(19) United States
(12) Patent Application Publication
(10) Pub. No.: US 2016/0050130 A1
(43) Pub. Date: Feb. 18, 2016

(54) DEVICE SWITCHING FOR A STREAMING SERVICE

(71) Applicants: Rickard Ljung, Helsingborg (SE); Samir Drincic, Lund (SE)

(72) Inventors: Rickard Ljung, Helsingborg (SE); Samir Drincic, Lund (SE)

(73) Assignee: SONY CORPORATION, Tokyo (JP)

(21) Appl. No.: 14/461,538

(22) Filed: Aug. 18, 2014

(51) Int. Cl. H04L 12/26; H04L 12/825; H04L 29/06

(52) U.S. Cl. CPC H04L 43/0811; H04L 65/60; H04L 47/25

(57) ABSTRACT

A method includes receiving registration information for a plurality of user devices associated with a streaming service. The method includes storing information about switching statistics for switching between the plurality of user devices that receive the streaming service. The method includes determining an expected switching scenario when switching between the plurality of user devices is probable to occur. The method also includes monitoring a current user device among the plurality of user devices that currently receives the streaming service to detect the expected switching scenario. The method further includes initiating preparation for handover of streaming service, and performing handover of the streaming service from the current user device to at least one resuming user device among the plurality of user devices.

### BACKGROUND

Multimedia streaming servers provide streaming video content to user devices. A typical multimedia streaming network arrangement includes nodes such as the multimedia streaming server, user devices, and support devices such as profile servers, applications servers, license servers, etc. The multimedia server communicates with the streaming client on user devices using a multimedia streaming protocol to provide the multimedia content, e.g. Moving Picture Experts Group (MPEG)-DASH. The content is delivered over a distribution network, e.g. a cellular network.

The multimedia streaming server includes functionality to store information about the last transmitted streaming segments to a particular user device. This enables other devices to continue the streaming session at the same time stamp at which the streaming session was stopped for the particular user device.

### SUMMARY

In one implementation, a computer-implemented method includes receiving registration information for a plurality of user devices associated with a streaming service. The method includes storing information about switching statistics for switching between the plurality of user devices that receive the streaming service. The method includes determining an expected switching scenario when switching between the plurality of user devices is probable to occur. The method includes monitoring a current user device among the plurality of user devices that currently receives the streaming service to detect the expected switching scenario. The method includes initiating preparation for handover of streaming service, and performing handover of the streaming service from the current user device to at least one resuming user device among the plurality of user devices.

In addition, the plurality of user devices may include one or more of a smartphone, a tablet, a television, or a gaming console.

In addition, initiating preparation for handover of the streaming service may further include initiating media rate selection associated with the at least one resuming user device.

In addition, initiating preparation for handover of the streaming service may further include initiating pre-buffering associated with the at least one resuming user device.

In addition, the at least one resuming user device may include at least two user devices.

In addition, receiving registration information may further include receiving a type of unit, a screen size, a decoding capability of each of the plurality of user devices.

In addition, storing information about switching statistics may further include storing an additional application that the user accessed within a predetermined time window of switching.

In addition, storing information bout switching statistics may further include storing an identification of devices that a user switches between for each switching instance.

In addition, storing information about switching statistics may further include storing a time of day at which the switching occurs.

In addition, storing information about switching statistics may further include storing a location of a resuming device at a time the switching occurs.

In addition, determining the expected switching scenario may further include receiving an indication from a user regarding a scenario in which switching is to occur.

In another implementation, a device may include a memory to store a plurality of instructions, and a processor configured to execute instructions in the memory to receive registration information for a plurality of user devices associated with a streaming service, store information about switching statistics for switching between the plurality of user devices that receive the streaming service, determine an expected switching scenario when switching between the plurality of user devices is probable to occur, monitor a current user device among the plurality of user devices that currently receives the streaming service to detect the expected switching scenario, initiate preparation for handover of streaming service, and perform handover of the streaming service from the current user device to at least one resuming user device among the plurality of user devices.

In addition, the plurality of user devices includes one or more of a smartphone, a tablet, a television, or a gaming console.

In addition, when initiating preparation for handover of the streaming service, the processor is further to initiate media rate selection associated with the at least one resuming user device.

In addition, when initiating preparation for handover of the streaming service, the processor is further to initiate pre-buffering associated with the at least one resuming user device.

In addition, the processor is further to initiate receive feedback from at least one user device regarding a time at which switching is probable to occur, and predict a switching time for the streaming service associated with a second device based on the feedback.

In addition, the at least one resuming user device comprises at least two user devices.

In addition, when receiving registration information, the processor is further to receive a type of unit, a screen size, a decoding capability of each of the plurality of user devices.

In yet another implementation, a non-transitory computer-readable medium includes instructions to be executed by a processor, for causing the processor to receive registration information for a plurality of user devices associated with a streaming service, store information about switching statistics for switching between the plurality of user devices that receive the streaming service, determine an expected switching scenario when switching between the plurality of user devices is probable to occur, monitor a current user device among the plurality of user devices that currently receives the streaming service to detect the expected switching scenario, initiate preparation for handover of streaming service, and perform handover of the streaming service from the current user device to at least one resuming user device among the plurality of user devices.

In addition, the instructions further include instructions for the processor to receive a type of unit, a screen size, a decoding capability of each of the plurality of user devices.

### BRIEF DESCRIPTION OF THE DRAWINGS

The accompanying drawings, which are incorporated in and constitute part of this specification, illustrate one or more embodiments described herein and, together with the description, explain the embodiments in the drawings:

FIG. 1 illustrates an exemplary network consistent with embodiments described herein;

FIG. 2 illustrates an exemplary configuration of one or more of the components of FIG. 1;

FIG. 3 is a functional block diagram of an exemplary device control unit consistent with embodiments described herein;

FIG. 4 is a functional block diagram of an exemplary user device consistent with embodiments described herein;

FIG. 5 depicts a functional block diagram of the switching statistics module of FIG. 3;

FIG. 6 depicts a functional block diagram of the device switching optimization module of FIG. 3;

FIG. 7 is a diagram illustrating switching from a single device to multiple devices, consistent with implementations described herein; and

FIG. 8 is a flow diagram of an exemplary process for optimizing switching a streaming service between devices associated with a particular user account, consistent with implementations described herein.

### DETAILED DESCRIPTION

The following detailed description refers to the accompanying drawings. The same reference numbers in different drawings may identify the same or similar elements. It should be noted that the drawings have not been drawn to scale and that the dimensions of certain features have been exaggerated for the sake of clarity. Also, the following detailed description is exemplary and explanatory only and is not restrictive of the invention, as claimed.

Embodiments described herein relate to devices, methods, and systems for optimizing switching between devices that receive a streaming service associated with a user account for a streaming service. A device control unit may interact with streaming servers and recipient user devices for media streaming services. The device control unit may monitor device switching statistics between different devices for the streaming service and take action upon expected upcoming handover scenarios for improved quality of service.

Consistent with embodiments described herein, the device control unit may monitor switching statistics based on location, timing, applications and other factors associated with switching of the devices during receipt of streaming service. Additionally, the methods and systems may prepare for and allow switching between single devices to multiple devices associated with a user account.

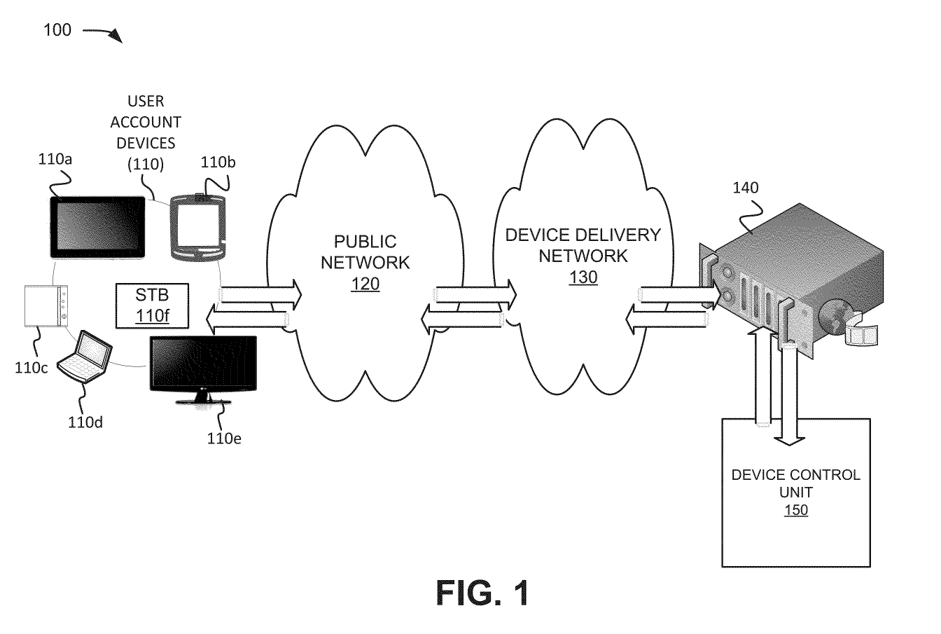

FIG. 1 illustrates an exemplary environment 100 in which systems and/or methods described herein may be implemented. As shown in FIG. 1, environment 100 may include a plurality of user devices 110a-110d (collectively referred to as user devices 110 and individually as user device 110), a public network 190, a service provider network 120, a streaming server 140, and a device control unit 150. Devices and/or networks of FIG. 1 may be connected via wired and/or wireless connections.

User devices 110 may include a device capable of receiving streaming service associated with a user account. For example, user devices 110 may include an electronic notepad and/or a tablet computer (110a); a mobile telephone, smart phone or cellular phone (110b); a gaming device or console (110c); a laptop or personal computer (110d); a set stop box (110e) and associated TV (110f); a personal digital assistant (PDA) that can include a telephone (not shown); etc. User devices 110 may request and receive video content from streaming server 140. Video content may include, for example, encoded video content in any of a variety of formats, including, for example, Multiview Video Coding (MVC), Moving Picture Experts Group (MPEG)-2 TS, MPEG-4 advanced video coding (AVC)/H.264. User devices 110 may, based on various factors, such as available bandwidth and output resolution, select a particular bit rate stream.

Network 120 may include the Internet or a combination of the Internet and additional networks (e.g., a private wide area network (WAN), cellular network, etc.) that are used to transport data. Although shown as a single element in FIG. 1, network 150 may include a number of networks.

Device delivery network 130 may include a local area network (LAN), a WAN, a cellular network, a satellite network, a fiber optic network, a private WAN, etc. In one implementation, network 130 may include an optical communication link, such as an optical fiber, coaxial cable, wireless (e.g., satellite, long term evolution (LTE), etc.) connection, etc.

Streaming server 140 may stream the multimedia content to user devices 110 using a device delivery network 130 selected by user device 110. Streaming server 140 may host the streaming video content that is to be distributed via networks (e.g., the Internet) to user devices 110. Streaming server 140 may be Internet facing (e.g., streaming server 140 may include a port directly connected to the Internet) and may provide a streaming uniform resource locator (URL) to deliver the video content (i.e., a transcoded video feed is provided as streaming video content that may be accessed through the streaming URL) directly to mobile user devices 140. Streaming server 140 may communicate with the streaming client using a multimedia streaming protocol, e.g. MPEG-DASH. Streaming server 140 may distribute or serve playlists and stream segments to user devices 110.

Device control unit 150 may optimize switching between user devices 110 that receive a streaming service associated with a user account. In some instances, device control unit 150 may allow switching between user devices 110 that receive open services without specific user accounts. Device control unit 150 may interact with streaming server 140 and recipient user devices 110 for media streaming services. Device control unit 150 may predict when switching between user devices 110 is likely to occur and initiate procedures to reduce the delay in streaming services as users switch user devices 110. Device control unit 150 may facilitate specific pre-buffering and media rate selection to improve device switching for multimedia streaming, such as improving (the smoothness of transition during multimedia streaming. Device control unit 150 may be coupled to the streaming service (i.e., streaming server 140). Device control unit 150 may be implemented as a part of the streaming server 140, or as a separate unit that can communicate with the involved user devices 110 during streaming. Device control unit 150 may be coupled with other devices, such as streaming server 140 via normal IP based traffic, with streaming server 140 connected to the Internet.

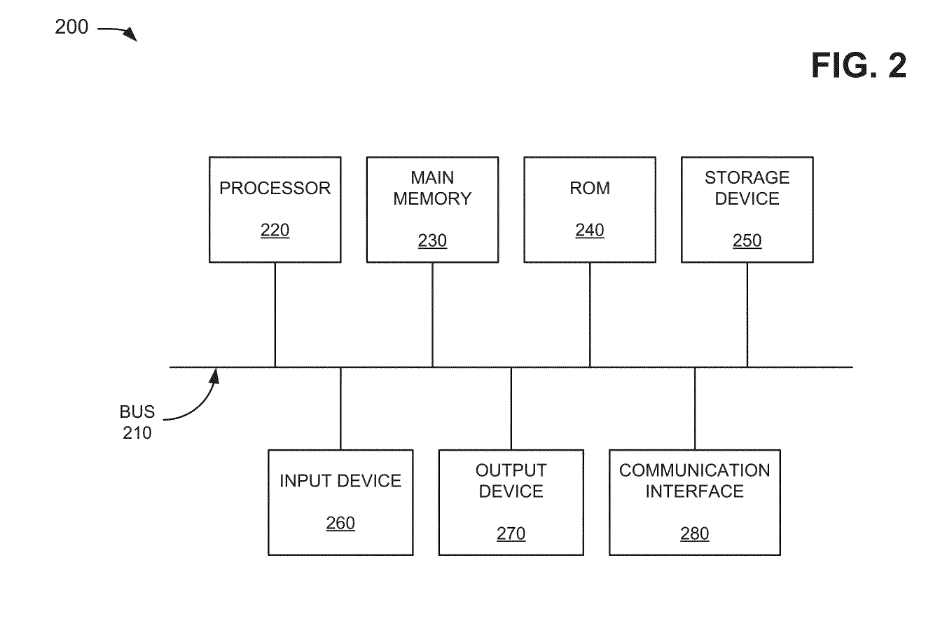

FIG. 2 is an exemplary diagram of a device 200 that may correspond to any of streaming server 140 and/or device control unit 150. As illustrated, device 200 may include a bus 210, processor 220, a main memory 230, a read-only memory (ROM) 240, a storage device 250, an input device 260, an output device 270, and a communication interface 280. Bus 210 may include a path that permits communication among the components of device 200.

Processor 220 may include a processor, microprocessor, or other type of processing logic that may interpret and execute instructions. Main memory 230 may include a random access memory (RAM) or another type of dynamic storage device that may store information and instructions for execution by processor 220. ROM 240 may include a ROM device or another type of static storage device that may store static information and/or instructions for use by processor 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, remote control, etc. Output device 270 may include a mechanism that outputs information to the operator, including a display, a printer, a speaker, etc. Communication interface 280 may include a transceiver that enables device 200 to communicate with other devices and/or systems. For example, communication interface 280 may include mechanisms for communicating with another device or system via a network, such as network 160.

As described herein, device 200 may perform certain operations in response to processor 220 executing machine-readable instructions (i.e., software instructions) contained in a computer-readable medium, such as main memory 230. A computer-readable medium may be defined as a physical or logical memory device. The machine-readable instructions may be read into main memory 230 from another computer-readable medium, such as storage device 250, or from another device via communication interface 280. The machine-readable instructions contained in main memory 230 may cause processor 220 to perform processes described herein. Alternatively, hardwired circuitry may be used in place of or in combination with machine-readable instructions to implement processes described herein. Thus, implementations described herein are not limited to any specific combination of hardware devices, circuitry, and/or machine-readable instructions.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

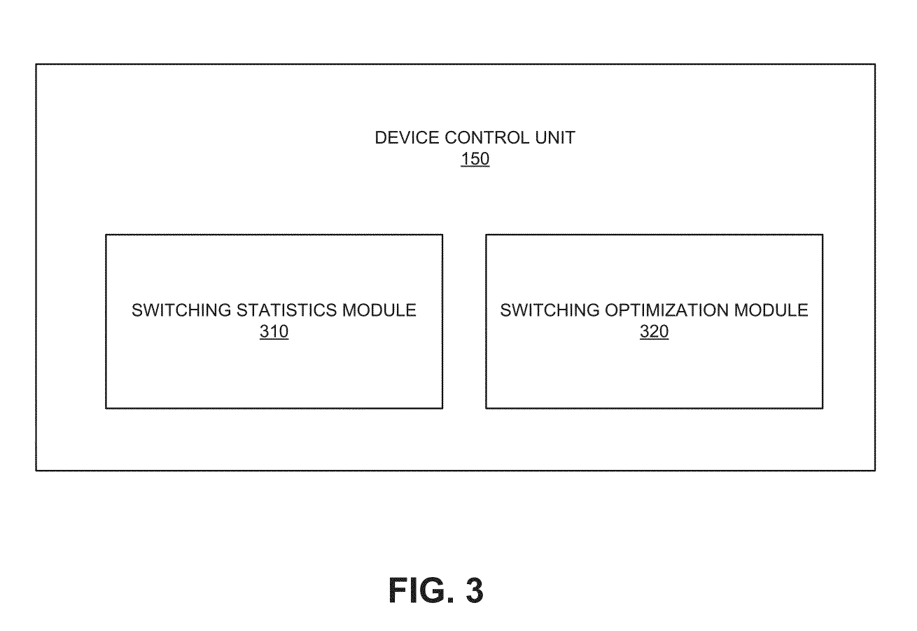

FIG. 3 is an exemplary functional block diagram of components implemented in device control unit 150. In an exemplary implementation, all or some of the components illustrated in FIG. 3 may be stored in memory 230. For example, referring to FIG. 3, memory 230 may include switching statistics module 310 and switching optimization module 320. In addition, various logic components illustrated in FIG. 3 may be implemented by processor 220 executing one or more programs stored in memory 230.

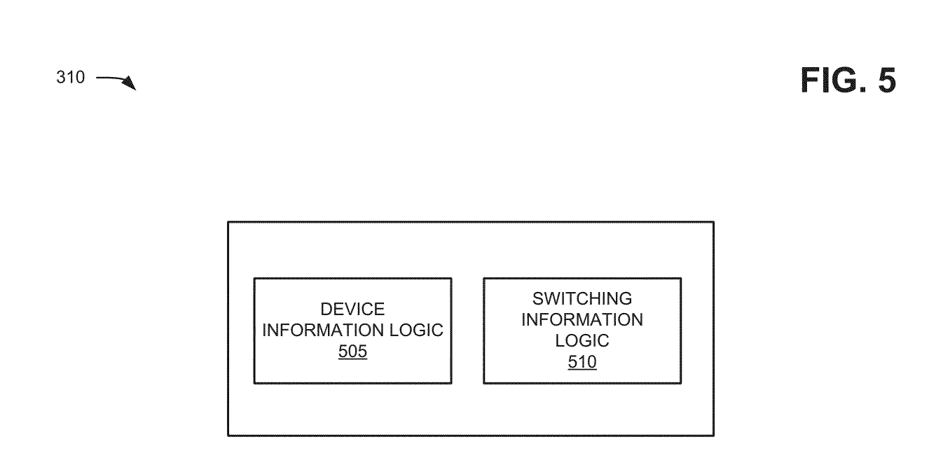

Switching statistics module 310 may determine statistics associated with switching between user devices 110 for a streaming service associated with a particular user account, such as described below with respect to FIG. 5. The device switching statistics may include, for example, which user devices 110 the user switches between when using the streaming service. Switching statistics module 310 may store device specific information about the different user devices 110 registered to each user. Switching statistics module 310 may store instances and statistics when the user pauses the streaming service at one specific user device 110 and switches to another specific user device 110. Switching statistics module 310 may store an identification of the user devices 110 that the user switches between for each switching instance.

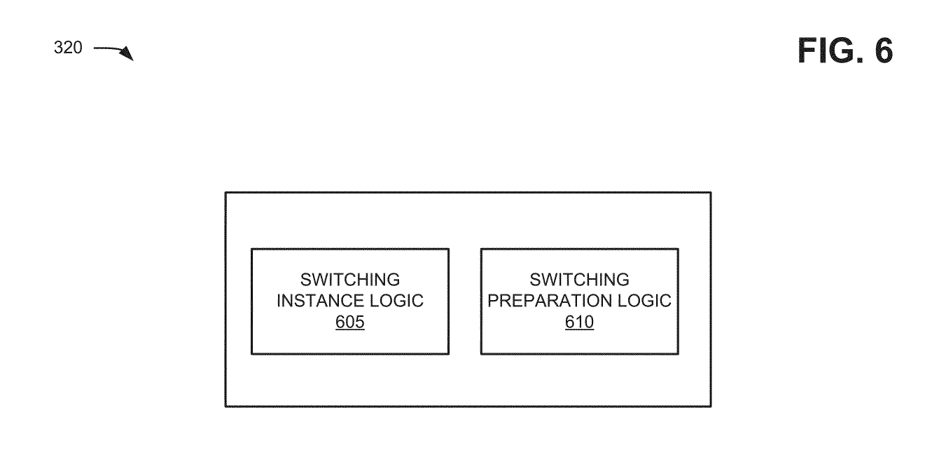

Switching optimization module 320 may optimize switching when switching between user devices 110, such as described below with respect to FIG. 6. During usage of the streaming service switching optimization module 320 may access stored information about device switching statistics. Switching optimization module 320 may monitor factors associated with switching based on statistics provided by switching optimization module 320 to determine the mobility and/or device switching during streaming sessions. Switching optimization module 320 may initiate streaming operations associated with the expected resuming device 110 on expected device switching occasions. Switching optimization module 320 may instruct expected target user devices 110 to prepare for streaming service continuity.

In some implementations, switching optimization module 320 may receive feedback from one or more user devices 110 (and or associated with particular user accounts) indicating likely times at which switching between user devices 110 associated with a streaming service may occur (e.g., switch to bigger screen devices). Switching optimization module 320 may use this information to predict likely switching times for other users not directly associated with the user devices 110 that provide the feedback.

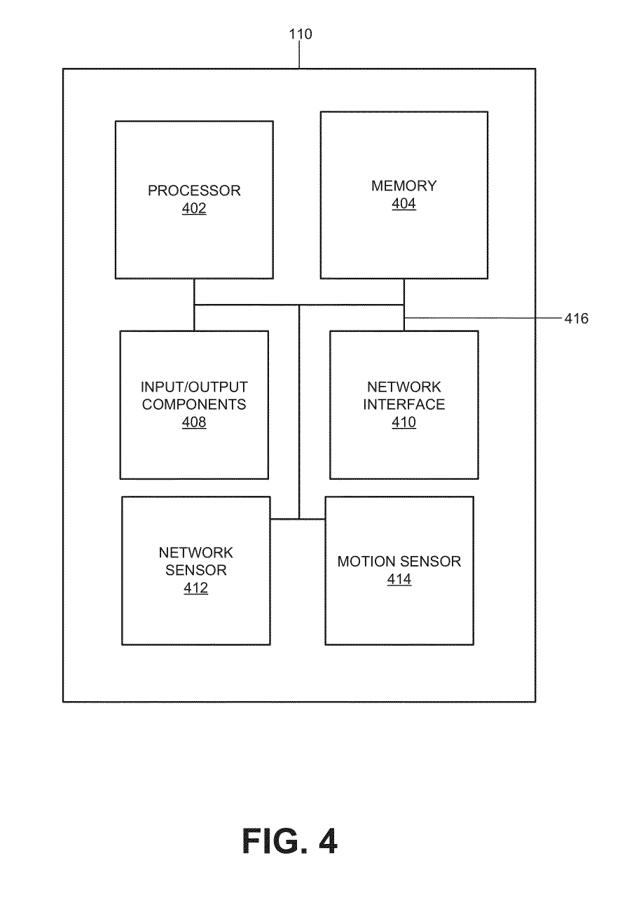

FIG. 4 is a diagram of an exemplary user device 110 in which the concepts described herein may be implemented. As shown in FIG. 4, device 110 may include a processor 402, a memory 404, input/output components 408, a network interface 410, a network sensor 412, a motion sensor 414 and a communication path 316. In different implementations, device 110 may include additional, fewer, or different components than the ones illustrated in FIG. 4. For example, device 110 may include additional network interfaces, such as interfaces for receiving and sending data packets.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling device 200.

Memory 404 may include static memory, such as read only memory (ROM), and/or dynamic memory, such as random access memory (RAM), or onboard cache, for storing data and machine-readable instructions. Memory 404 may also include storage devices, such as a floppy disk, CD ROM, CD read/write (R/W) disc, and/or flash memory, as well as other types of storage devices.

Memory 404 may include machine readable instructions to provide statistics associated with switching (e.g., based on instructions provided by device control unit 150). Memory may include statistical switching application 406. Statistical switching application 406 may interact with device control unit 150 and/or streaming server 140 to collect and transmit data regarding switching between user devices 110 and concurrent motion, applications, location, etc., associated with a particular user device 110 at a time of switching between user devices 110.

Input/output components 408 may include a display screen (e.g., touchscreen display 204, etc.), a keyboard, a mouse, a speaker, a microphone, a Digital Video Disk. (DVD) writer, a DVD reader, Universal Serial Bus (USB) lines, and/or other types of components for converting physical events or phenomena to and/or from digital signals that pertain to device 200. Input/output components 408 may also include a motion detecting camera that may detect a position of a user of device 200.

Network interface 410 may include a transceiver that enables device 200 to communicate with other devices and/or systems. For example, network interface 410 may include mechanisms for communicating via a network, such as the Internet, a terrestrial wireless network (e.g., a wireless local area network (WLAN)), a cellular network, a satellite-based network, a wireless personal area network (WPAN), etc. Additionally or alternatively, network interface 410 may include a modem, an Ethernet interface to a LAN, and/or an interface/connection for connecting device 200 to other devices (e.g., a Bluetooth interface).

Network sensor 412 may provide information regarding contact received from user 104 at a particular portion of a touchscreen display of device 200.

Motion sensor 414 may include an accelerometer, gyroscope, etc., that provides information regarding motion of device 200. Motion sensor 414 may periodically determine motion of device 110. Additionally, motion sensor 414 may detect a position and/or motion of external objects, including the user, with regard to device 110.

Communication path 416 may provide an interface (e.g., a bus) through which components of device 110 may communicate with one another.

FIG. 5 is an exemplary functional block diagram of switching statistics module 310. As shown in FIG. 5, switching statistics module 310 may include device information logic 505 and switching information logic 510.

Device information logic 505 may store device specific information and monitor ongoing streaming sessions. Whenever a user registers a device 110 to the streaming service device information logic 505 may add information about the user device 110 to an associated data store. The stored information may include a type of unit (mobile or stationary), screen size, decoding capabilities etc.

Switching information logic 510 may monitor information associated with instances of switching including a location, an application, a time, a type of program, concurrent application user (e.g., telephone), etc. For example, switching information logic 510 may monitor an additional application that the user accessed within a predetermined time window of switching between user devices 110. If the user is likely to switch user devices 110 after accessing this application, switching information logic 510 may store this statistic. Switching information logic 510 may store this information in association with the user profile and particular user devices 110.

FIG. 6 is an exemplary functional block diagram of switching optimization module 320. As shown in FIG. 5, switching optimization module 320 may include switching instance logic 505 and switching preparation logic 510.

Switching instance logic 505 may monitor device switching statistics and take action upon expected upcoming handover scenarios. Switching instance logic 505 may take the stored device switching statistics into account for improved mobility performance. For example, switching instance logic 505 may monitor parameters associated with previous instances of switching between devices 110, such as a distance between the devices 110, a particular time of day, a current program viewed, additional activity associated with the devices 110, etc. Switching instance logic 505 may provide notification of a switching instance to switching preparation logic 510 when required conditions are detected.

Switching preparation logic 510 may implement device specific pre-buffering, ensuring that the expected device switching is achieved with good end user quality experience. In instances in which a switch between different user devices 110 for a streaming session occurs, a time delay from a time the streaming session is stopped on one user device 110 and started again with the new user device 110. In case of mobility or shared mobility between user devices 110 when streaming media, switching preparation logic 510 may pre-initiate some activity to reduce the time delay in startup of the streaming session at a resuming user device 110 or user devices 110.

When switching preparation logic 510 receives information that a device switching is likely to occur (e.g., based on an alert from switching instance logic 605), switching preparation logic 510 may interact with the expected resuming user device 110 to continue the streaming service. The expected resuming user device 110 may then take action to initiate streaming service, e.g. download media description documentation and initiate a first pre-buffering activity in order to be prepared for the expected service continuity after the device switching. With pre-buffering, the expected resuming user device 110 may also ensure good video quality immediately after the device switching.

Switching preparation logic 510 may manage streaming handover between user devices 110 in order to reduce the handover delays, improve the time to start playback and improve streaming buffer handling in user devices 110.

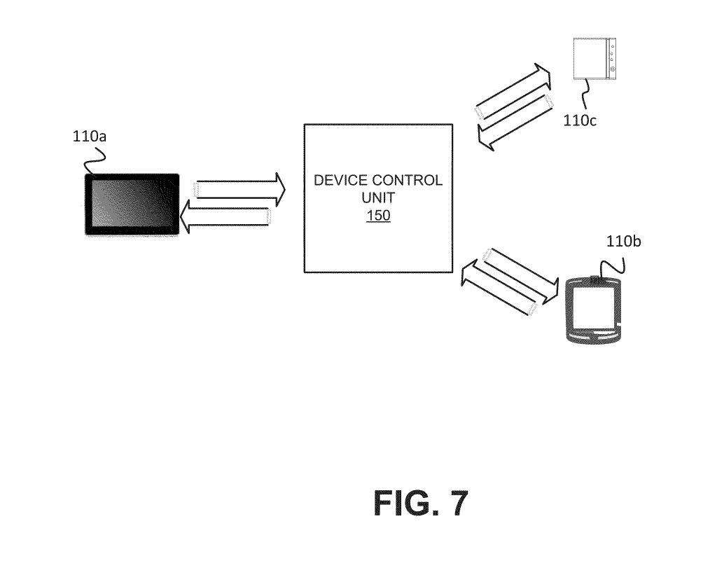

FIG. 7 is a diagram illustrating switching from a single device to multiple devices. As shown in FIG. 7, user device 110a, user device 110b, and user device 110c are associated with a user account and may participate in a streaming session controlled by device control unit 150.

A streaming session may be in progress at a particular user device 110 (e.g., user device 110a). The initial user device 110a may be a device that is known to host multiple users (e.g., a husband and wife). The multiple users may be associated with multiple different additional devices 110 (e.g., the husband may be associated with user device 110b and the wife may be associated with user device 110c under a same user or group account). Device control unit 150 may receive instructions to prepare to switch to multiple user devices 110 associated with a common user account. The switch may be initiated based on factors such as the presence of the expected resuming user devices 110 (user device 110b and user device 110c), motion by either or both of the pausing device 110a and the resuming devices 110b and 110c, detection of a network, current activity at the user devices 110, a particular time, initiation of a particular program (or segment of a program), etc.

Device control unit 150 may initiate preparation for a switch from a device 110a that currently receives streaming service to multiple devices 110b and 110c based on, for example, the proximity of the pausing device 110a to the resuming devices 110b and 110c. For example, device control unit 150 may detect multiple devices after a vehicle (or mobile network associated with a vehicle) arrives within a predetermined proximity of a device associated with a home network. Based on user instruction device control unit 150 may bifurcate the streaming service currently received at the car system to individual phone systems (e.g., user devices 110b and 110c).

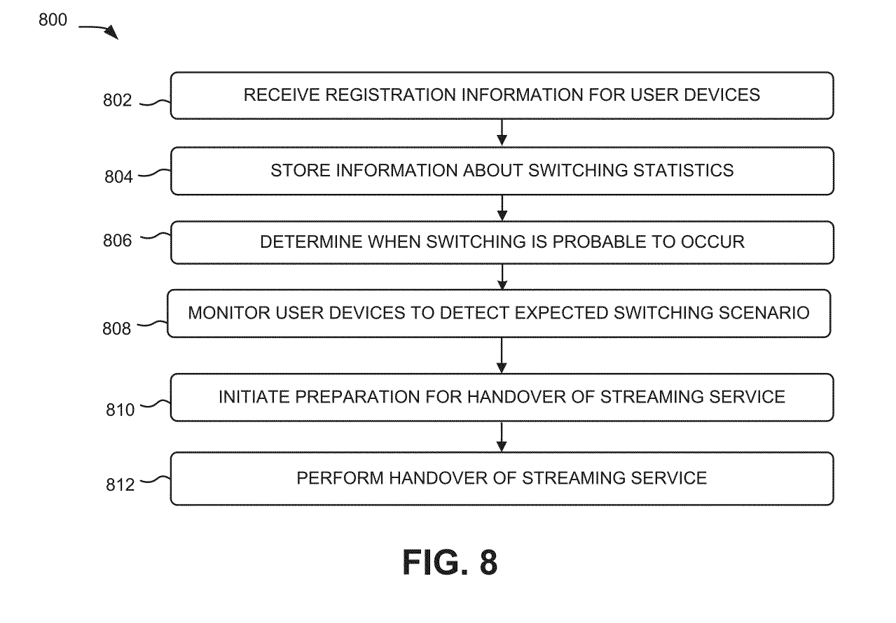

FIG. 8 is a flowchart of an exemplary process 800 for optimizing switching in a streaming service from a first device to a second device associated with a particular user account (and/or streaming service) in a manner consistent with implementations described herein. Process 800 may execute in device control unit 150, such as by processor 220. It should be apparent that the process discussed below with respect to FIG. 8 represents a generalized illustration and that other elements may be added or existing elements may be removed, modified or rearranged without departing from the scope of process 800.

At block 802, device control unit 150 may receive registration information for user devices associated with a particular user account. For example, when a user registers a user device 110, device control unit 150 may collect information about the particular user devices 110. The information may include a type of device, formats of video used by the device 110, processing capability, etc. Device control unit 150 may store information about screen size and speed is stored associated with each user device 110.

Device control unit 150 may store information about switching statistics between devices 110 associated with streaming service (block 804). For example, device control unit 150 may collect statistics associated with switching during streaming service for a particular user account that includes multiple devices 110. Device control unit 150 may collect information (e.g., particular parameters such as a time of day, location of devices 110, programs being watched, whether the user attempted to access particular features, etc.) about specific instances of switching between devices 110 while receiving streaming service.

Device control unit 150 may determine when it is probable that switching between devices 110 may occur (block 806). For example, device control unit 150 may determine that a user is likely to switch between devices based on a combination of factors, such as motion of one or more of the devices 110, location, timing element, specific programs, features accessed by the user, proximity of devices 110 to each other, time of day, etc. Device control unit 150 may determine the likelihood based on a threshold probability which may be supplied by the user in some instances. Device control unit 150 may also monitor whether the expected resuming device 110 is currently switched on.

According to one embodiment, device control unit 150 may receive an indication from a user regarding a scenario in which switching between user devices 110 is to occur. For example, the user may provide input that the switching may occur at a particular location, at a particular time of day, when particular programs or segments are streamed, etc.

At block 808, device control unit 150 may monitor user devices 110 to detect an expected switching scenario. For example, device control unit 150 may monitor a current arrangement of devices 110 to detect instances of likely probability of switching. In some instances, device control unit 110 may monitor a location of an expected resuming device 110 or a relative position of an expected resuming device 110 with respect to a user device 110 that is currently receiving streaming service.

Device control unit 150 may initiate preparation for handover of streaming service from the devices 110 currently receiving streaming service to the expected resuming user devices 110 (block 810). Device control unit 150 may initiate processes to prepare for streaming handover from user device 110 currently receiving streaming service to expected resuming user devices 110. For example, device control unit 150 may provide instructions to the expected user device 110 to begin pre-buffering of data or prep the streaming server 140 about the expected resuming user device 110 and what content the expected resuming user device 110 is likely to request (e.g., a format, screen size, data rate, etc.).

At block 812, device control unit 150 may perform handover of streaming service between user devices 110. Device control unit 150 may provide instructions for streaming server 140 to end the streaming service to one user device 110 and resume on another device 110. For example, device control unit 150 may split the streaming service onto multiple devices to restart playback. The resuming user devices 110 may resume at a same time stamp that the pausing user device 110 stops. The end user may provide instruction on which devices 110 to restart the program. Device control unit 150 may pre-buffer the streaming service on more than one device 110.

Systems and methods described herein may monitor device switching statistics and take action to prepare devices to optimize streaming service upon expected upcoming handover scenarios. The systems may minimize the delay at handover as well as ensure that video is properly formatted for the expected resuming devices.

The foregoing description of implementations provides illustration, but is not intended to be exhaustive or to limit the implementations to the precise form disclosed. Modifications and variations are possible in light of the above teachings or may be acquired from practice of the teachings.

In the above, while series of blocks have been described with regard to the exemplary processes, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computer-implemented method, the method comprising:
receiving registration information for a plurality of user devices associated with a streaming service;
storing information about switching statistics for switching between the plurality of user devices that receive the streaming service;
determining an expected switching scenario when switching between the plurality of user devices is probable to occur;
monitoring a current user device among the plurality of user devices that currently receives the streaming service to detect the expected switching scenario;
initiating preparation for handover of streaming service; and
performing handover of the streaming service from the current user device to at least one resuming user device among the plurality of user devices.

2. The computer-implemented method of claim 1, wherein the plurality of user devices include one or more of a smartphone, a tablet, a television, or a gaming console.

3. The computer-implemented method of claim 1, wherein initiating preparation for handover of the streaming service further comprises:
initiating media rate selection associated with the at least one resuming user device.

4. The computer-implemented method of claim 1, wherein initiating preparation for handover of the streaming service further comprises:
initiating pre-buffering associated with the at least one resuming user device.

5. The computer-implemented method of claim 1, wherein the at least one resuming user device comprises at least two user devices.

6. The computer-implemented method of claim 1, wherein receiving registration information further comprises:
receiving a type of unit, a screen size, a decoding capability of each of the plurality of user devices.

7. The computer-implemented method of claim 1, wherein storing information about switching statistics further comprises:
storing an additional application that the user accessed within a predetermined time window of switching.

8. The computer-implemented method of claim 1, wherein storing information about switching statistics further comprises:
storing an identification of devices that a user switches between for each switching instance.

9. The computer-implemented method of claim 1, wherein storing information about switching statistics further comprises:
storing a time of day at which the switching occurs.

10. The computer-implemented method of claim 1, wherein storing information about switching statistics further comprises:
storing a location of a resuming device at a time the switching occurs.

11. The computer-implemented method of claim 1, wherein determining the expected switching scenario further comprises:
receiving an indication from a user regarding a scenario in which switching is to occur.

12. A device, comprising:
a memory to store a plurality of instructions; and
a processor configured to execute instructions in the memory to:
receive registration information for a plurality of user devices associated with a streaming service;
store information about switching statistics for switching between the plurality of user devices that receive the streaming service;
determine an expected switching scenario when switching between the plurality of user devices is probable to occur;
monitor a current user device among the plurality of user devices that currently receives the streaming service to detect the expected switching scenario;
initiate preparation for handover of streaming service; and
perform handover of the streaming service from the current user device to at least one resuming user device among the plurality of user devices.

13. The device of claim 12, wherein the plurality of user devices include one or more of a smartphone, a tablet, a television, or a gaming console.

14. The device of claim 12, wherein, when initiating preparation for handover of the streaming service, the processor is further to:
initiate media rate selection associated with the at least one resuming user device.

15. The device of claim 12, wherein, when initiating preparation for handover of the streaming service, the processor is further to:
initiate pre-buffering associated with the at least one resuming user device.

16. The device of claim 12, wherein the processor is further to:
receive feedback from at least one user device regarding a time at which switching is probable to occur; and
predict a switching time for the streaming service associated with a second device based on the feedback.

17. The device of claim 12, wherein the at least one resuming user device comprises at least two user devices.

18. The mobile device of claim 12, wherein, when receiving registration information, the processor is further to:
receive a type of unit, a screen size, a decoding capability of each of the plurality of user devices.

19. A non-transitory computer-readable medium including instructions to be executed by a processor, the instructions including one or more instructions, when executed by the processor, for causing the processor to
receive registration information for a plurality of user devices associated with a streaming service;
store information about switching statistics for switching between the plurality of user devices that receive the streaming service;
determine an expected switching scenario when switching between the plurality of user devices is probable to occur;
monitor a current user device among the plurality of user devices that currently receives the streaming service to detect the expected switching scenario;
initiate preparation for handover of streaming service; and
perform handover of the streaming service from the current user device to at least one resuming user device among the plurality of user devices.

20. The non-transitory computer-readable medium of claim 19, wherein, when receiving registration information, the instructions further include instructions for causing the processor to:
receive a type of unit, a screen size, a decoding capability of each of the plurality of user devices.
